(19) United States
(12) Patent Application Publication
(10) Pub. No.: US 2014/0036535 A1
(43) Pub. Date: Feb. 6, 2014

(54) BACKLIGHT MODULE AND AN LED LIGHT BAR THEREOF

(71) Applicants: Kuangyao Chang, Shenzhen (CN); Hu He, Shenzhen (CN); Chechang Hu, Shenzhen (CN)

(72) Inventors: Kuangyao Chang, Shenzhen (CN); Hu He, Shenzhen (CN); Chechang Hu, Shenzhen (CN)

(73) Assignee: SHENZHEN CHINA STAR OPTOELECTRONICS TECHNOLOGY CO., LTD., Shenzhen (CN)

(21) Appl. No.: 13/375,779

(22) PCT Filed: Jul. 20, 2011
(86) PCT No.: PCT/CN11/77399

§ 371 Date: Dec. 2, 2011

(30) Foreign Application Priority Data
Apr. 20, 2011 (CN) 201110099654.0

(51) Int. Cl. F21V 8/00; F21K 99/00

(52) U.S. Cl. CPC G02B 6/0085; F21K 9/00
USPC 362/612; 362/382

(57) ABSTRACT

A backlight module and a light emitting diode (LED) light bar thereof are proposed. The backlight module includes a plurality of LEDs, at least one circuit board, a heat sink, a plurality of screws, and a light guide plate (LGP). The plurality of LEDs are arranged on the at least one circuit board. A plurality of screws are arranged on the at least one circuit board and the arrangement method thereof depends on temperature distribution of the at least one circuit board. The plurality of screws are inserted between the plurality of LEDs and are arranged at an unequally distance so that temperature can be evenly distributed over the LED light bar, thereby improving image quality of display devices.

### BACKGROUND OF THE INVENTION

1. Field of the Invention

The present invention relates to a backlight module and a light emitting diode (LED) light bar thereof, and more particularly, to an uneven (unequally spaced) arrangement of screws on the LED light bar.

2. Description of the Prior Art

It is known that an LED light bar bearing LEDs serves as a light source in a backlight module of a display device. A structural design of the LED light bar greatly affects image quality of the display device. For example, temperature distribution over the LED light bar is one of the key factors that determine image quality of the display device. Referring to FIG. 1 showing a schematic diagram of a partial structure of the conventional display device 1, the display device 1 comprises a housing 3 and an optical film 5. Once temperature is not evenly distributed over the LED light bar, the housing 3 and the optical film 5 are easy to be warped or deformed like waves. Particularly, if the LED has poor luminous efficiency, the temperature of devices (e.g., a circuit board) increases easily. An increase in temperature of devices will cause deformation of the devices, thereby influencing the life span of the LED light bar. Referring to FIG. 2 showing that temperature of the LED light bar in the display device 1 is not evenly distributed, this induces another problem. In FIG. 2, a large area 6 of the display device 1 covered by oblique lines shows a normal image while the image becomes whiter at four corners 7. This is a phenomenon known as “light leakage”. As such, there is a considerable need for a solution to improvement of unevenly distributed temperature over the LED light bar in order to improve image quality of display devices.

The conventional technology shows that temperature distribution over the LED light bar is affected by three factors: (1) the air layer; (2) the density distribution of LEDs on the LED light bar; (3) the density and the position of screws on the LED light bar.

FIG. 3 shows a cross-sectional view of a combination of an LED light bar 60 and a heat sink 16 used in a conventional display device 58. A circuit board 14 in the LED light bar 60 is fixed to the heat sink 16 using two screws 12 at the left and right sides.

Referring to FIG. 4, FIG. 4 shows a structure diagram of another conventional LED light bar 60 and a coordinate graph illustrating a temperature profile thereof. In the coordinate graph as shown in FIG. 4, a vertical axis 40 indicates temperature, and a horizontal axis 45 indicates the length of the LED light bar 60 (or the length of the circuit board 14). A temperature distribution curve 20 indicates that temperature reaches its highest value in the middle of the temperature distribution curve 20 and decreases gradually toward both ends of the temperature distribution curve 20 because of an accumulation of heat generated by a plurality of LEDs 10.

Referring to FIG. 5, FIG. 5 shows a structure diagram of another conventional LED light bar 65 and a coordinate graph illustrating a temperature profile thereof for delivering information about the effects of density distribution of screws and the position of screws on temperature distribution. A temperature distribution curve 23 indicates that temperature which each of the screws 12 corresponds to is lower than temperature between the two screws 12. Thus, a disposition of the screws 12 affects temperature distribution over the LED light bar 65.

Referring to FIG. 6, FIG. 6 shows a structure diagram of another conventional LED light bar 70 and a coordinate graph illustrating a temperature profile thereof for illustrating the effects of two circuit boards 14 arranged in a row in the conventional LED light bar 70 on temperature distribution. An air gap 30 exists between the circuit boards 14. A temperature distribution curve 22 indicates that temperature which the air gap 30 corresponds to decreases.

Therefore, temperature can be evenly distributed over the LED light bar as long as the arrangement of screws on the LED light bar is improved, thereby improving image quality of the display device.

### SUMMARY OF THE INVENTION

Therefore, it is an object of the present invention to provide a backlight module and an LED light bar thereof. Temperature can be evenly distributed over the LED light bar through an appropriate arrangement of screws, thereby improving image quality of display devices.

According to the present invention, a LED light bar comprises a plurality of LEDs, at least a circuit board, a heat sink, and a plurality of screws. The plurality of LEDs are used for emitting light. The at least one circuit board comprises a surface where the plurality of LEDs and at least one trace for driving the plurality of LEDs are disposed. The plurality of LEDs are arranged in a direction parallel to the surface of the circuit boards. The heat sink is disposed at a back side of the at least one circuit board, and comprising two ends and a middle portion therebetween, and is used for dissipating heat generated by the LEDs. The plurality of screws are inserted between the plurality of LEDs, and are arranged at an unequal distance.

In one aspect of the present invention, the plurality of screws are used for fixing the circuit board on the heat sink. The plurality of screws on the circuit board are arranged at an unequal distance. The distance between any two adjacent screws is gradually increased from the middle portion to the two ends of the heat sink. Some of the screws are more densely arranged in the middle portion of the heat sink and the other of the screws at the two ends of the heat sink are more sparsely arranged.

In another aspect of the present invention, the at least one circuit board comprises a first circuit board and a second circuit board arranged with the first circuit board adjacently. The plurality of LEDs are arranged in a direction parallel to the surface of the first and second circuit boards. The plurality of screws are inserted between the plurality of LEDs, and the distance between any two adjacent screws is gradually increased from the middle portion to the two ends of the heat sink. The distance between the two adjacent screws situated at the junction area of the first circuit board and the second circuit board is shorter than that between the other two adjacent screws disposed on the first and second circuit boards.

According to the present invention, a backlight module disposed on a frame of a display device is proposed. The backlight module comprises a plurality of LEDs, at least one circuit board, a heat sink, a plurality of screws, and a light guide plate. The plurality of LEDs are used for emitting light. Each circuit board comprises a surface where the plurality of LEDs and at least one trace for driving the plurality of LEDs are disposed. The heat sink disposed at a back side of the plurality of circuit boards comprises a middle portion and two ends of the middle portion. The plurality of screws are used for fixing the plurality of circuit boards on the heat sink, and are arranged at an unequal distance. The plurality of LEDs are arranged in alignment with the surfaces of the plurality of circuit boards. The plurality of screws are inserted between the plurality of LEDs, and the distance between any two adjacent screws is gradually increased from the middle portion to the two ends of the heat sink.

The present invention adopts the technology mentioned above for purpose of making temperature evenly distributed. That is, the design and arrangement of a plurality of screws depends upon temperature distribution over the LED light bar, replacing the equally spaced arrangement of a plurality of screws in the conventional technology. In this way, temperature can be more evenly distributed over the LED light bar, thereby improving image quality of display devices.

According to the LED light bar used for the present invention, the arrangement of the plurality of screws is also determined by temperature distribution over the LED light bar when two circuit boards (a first circuit board and a second circuit board) are combined. The design method used here is the same as the above-mentioned design method. The plurality of screws are arranged at an unequal distance so that temperature can be evenly distributed over the LED light bar. According to the LED light bar used for the present invention, the arrangement of the plurality of screws is also determined by temperature distribution over the LED light bar when a plurality of circuit boards (multiple circuit boards) are combined. The design method used here is the same as the above-mentioned design method. The plurality of screws are arranged at an unequal distance so that temperature can be evenly distributed over the LED light bar.

### BRIEF DESCRIPTION OF THE DRAWINGS

FIG. 1 shows a schematic diagram of a partial structure of a conventional display device.

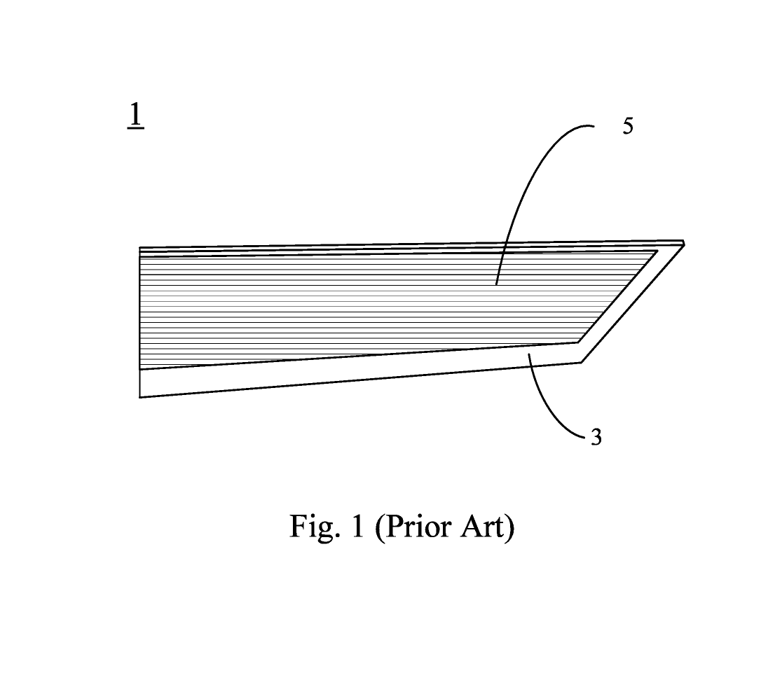

FIG. 2 shows that temperature of the LED light bar in the display device is not evenly distributed.

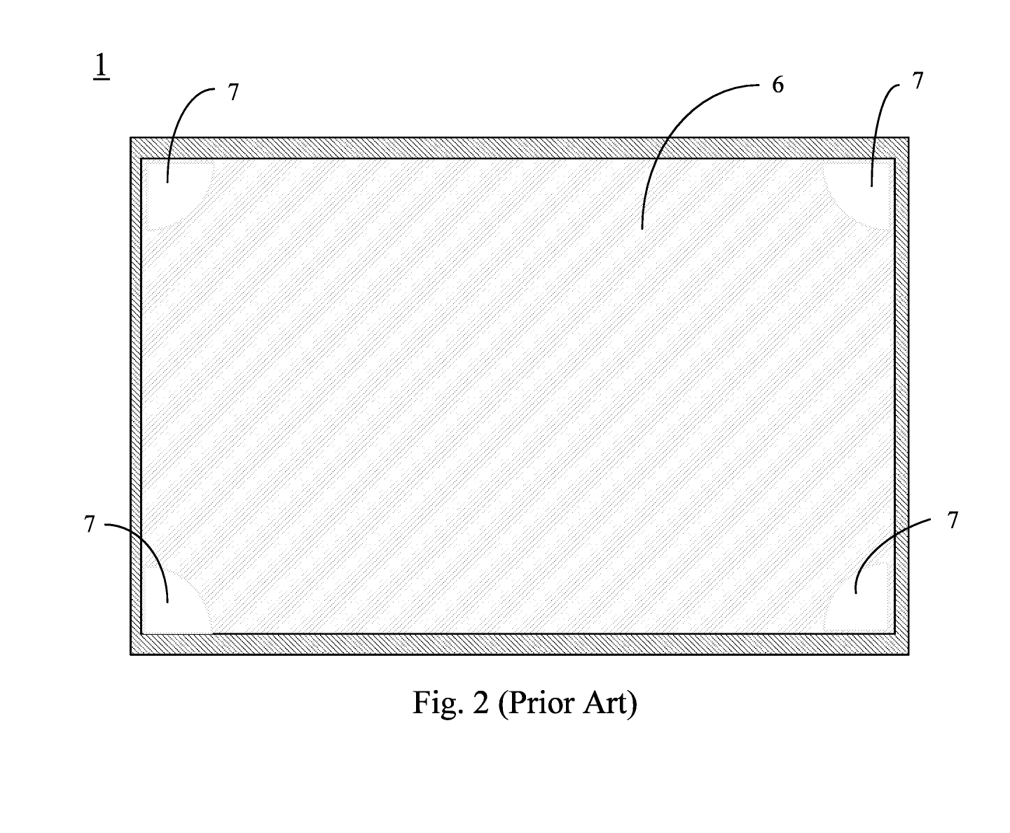

FIG. 3 shows a cross-sectional view of a combination of an LED light bar and a heat sink used in a conventional display device.

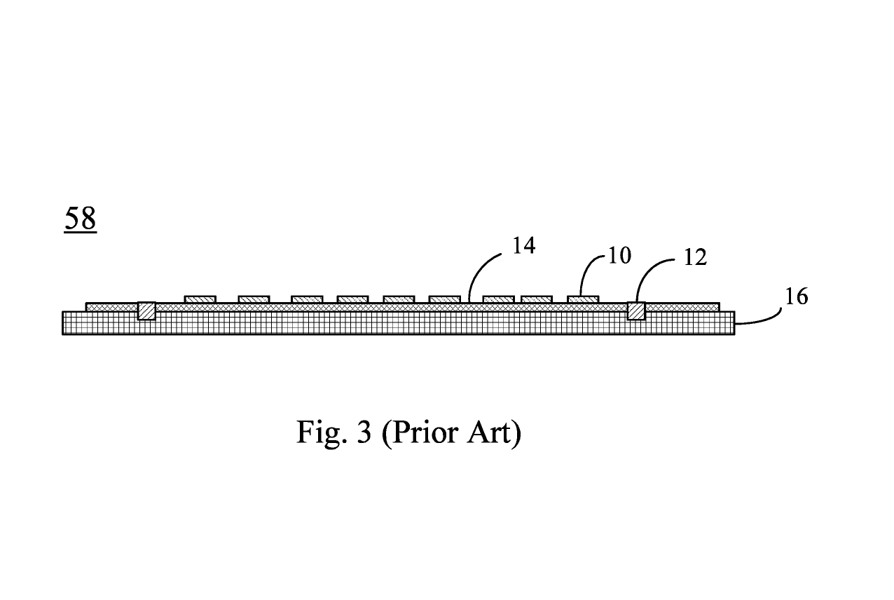

FIG. 4 shows a structure diagram of another conventional LED light bar and a coordinate graph illustrating a temperature profile thereof.

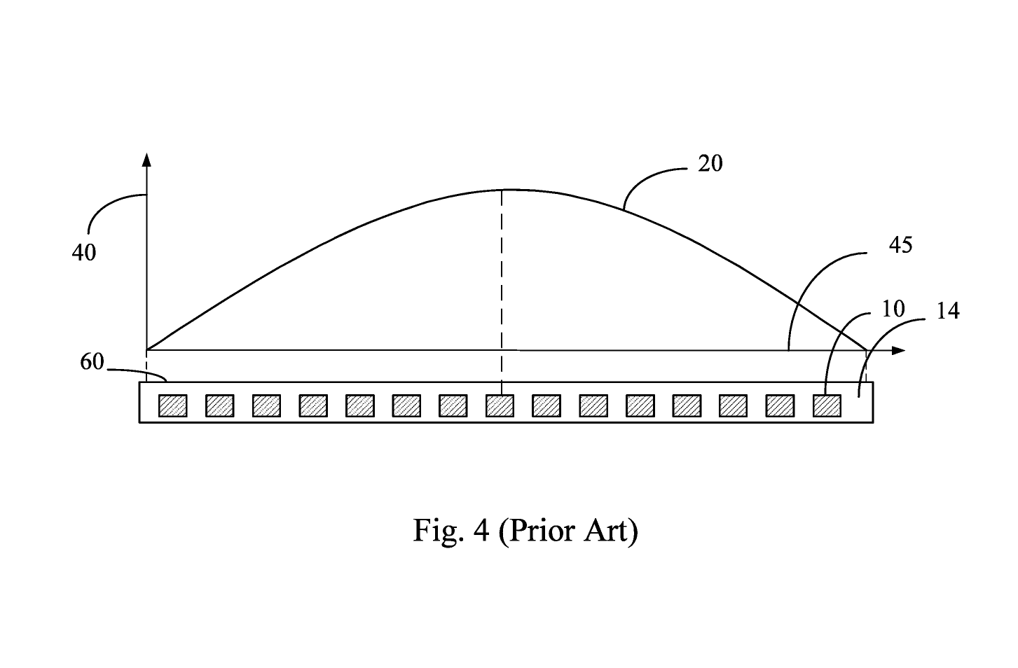

FIG. 5 shows a structure diagram of another conventional LED light bar and a coordinate graph illustrating a temperature profile thereof.

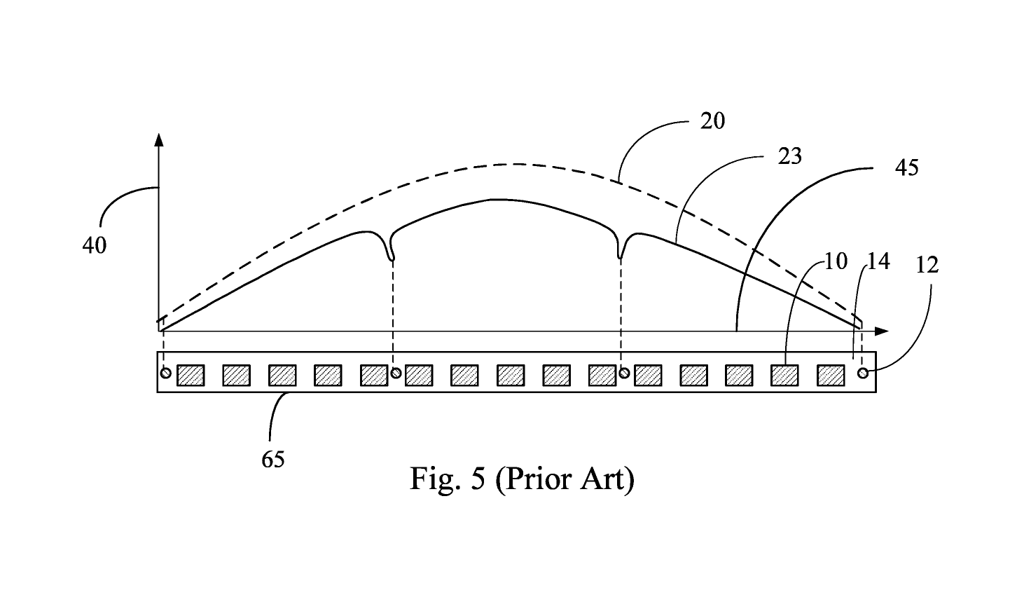

FIG. 6 shows a structure diagram of another conventional LED light bar and a coordinate graph illustrating a temperature profile thereof

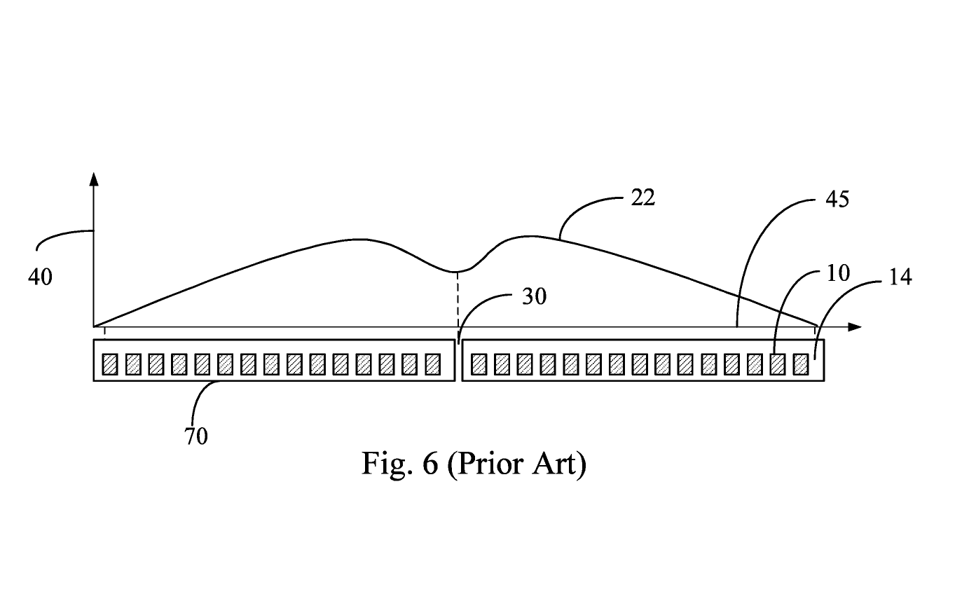

FIG. 7 shows an LED light bar according to a first embodiment of the present invention.

FIG. 8 shows an LED light bar according to a second embodiment of the present invention.

FIG. 9 shows a structure diagram of an LED light bar and a coordinate graph illustrating a temperature profile thereof according to a first embodiment of the present invention.

FIG. 10 shows a structure diagram of the LED light bar and a coordinate graph illustrating a temperature profile thereof according to a second embodiment of the present invention.

FIG. 11 shows a backlight module according to a third embodiment of the present invention.

### DETAILED DESCRIPTION OF THE PREFERRED EMBODIMENTS

Although the present invention has been explained by the embodiments shown in the drawings described below, it should be understood to the ordinary skilled person in the art that the invention is not limited to the embodiments, but rather various changes or modifications thereof are possible without departing from the spirit of the invention. Accordingly, the scope of the invention shall be determined only by the appended claims and their equivalents.

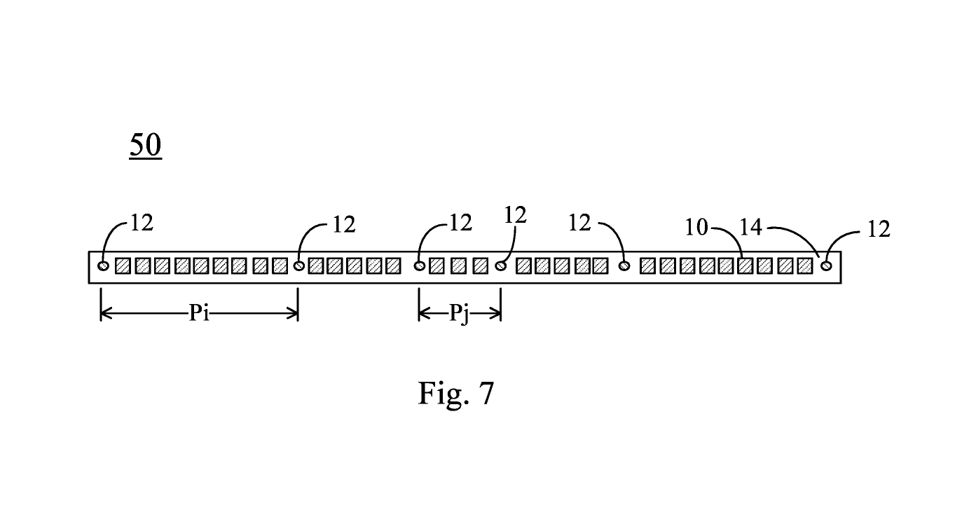

Referring to FIG. 7, FIG. 7 shows an LED light bar 50 according to a first embodiment of the present invention. The LED light bar 50, disposed on a heat sink (not shown), is a light source of a backlight module (not shown) used in a display device. The LED light bar 50 comprises a plurality of LEDs 10, a circuit board 14, a heat sink (not shown), and a plurality of screws 12. It is notified that the backlight module according to the present invention is a side light type backlight module. The LED light bar 50 is disposed at sides of a light guide plate (LGP) in the backlight module. Light from the plurality of LEDs progresses into the sides of the LGP. The light is guided by the LGP and serves as a light source for the entire display device. The circuit board 14 acts as a first circuit board comprising a surface where the plurality of LEDs 10 are disposed and at least one trace, and is used for driving the plurality of LEDs 10. The plurality of LEDs 10 are arranged in a direction parallel to the surface of the circuit board 14. The trace is connected to the plurality of LEDs 10. Voltage applied on the plurality of LEDs 10 causes the plurality of LEDs 10 to be illuminated. When the plurality of LEDs 10 are illuminated, thermal energy is produced. The thermal energy affects the circuit board 14 directly because the circuit board 14 bears the plurality of LEDs 10. So the circuit board 14 may be made of a glass fiberboard e.g. FR4, or a meal core printed circuit board (MCPCB), with better heat dissipation performance, or ceramic materials. A heat sink is disposed at a back side of the first circuit board 14 and comprises two ends and a middle portion therebetween. The plurality of screws 12 may be fabricated from a heat conducting material (e.g., metals) or a non-heat conducting material for fixing the first circuit board 14 on a frame (not shown). The plurality of screws 12 are disposed on the same surface of the circuit board 14 and are inserted between the plurality of LEDs 10 separately. The intervals between two neighboring screws 12 are unequally arranged. For example, some of the screws 12 are more densely arranged in the middle portion of the heat sink (not shown) while the other of the screws 12 at the two ends of the heat sink (not shown) are more sparsely arranged. In other words, the distance between any two adjacent screws 12 is gradually increased from the middle portion to the two ends of the heat sink. (For example, the number of LEDs 10 is 9, 5, 3, 5, and 9 from left to right between two adjacent screws 12 in FIG. 7.) Taking luminance uniformity of the plurality of LEDs 10 into considerations, the interval between the two adjacent LEDs 10 are equal on the circuit board 14 though the interval between the two adjacent screws 12 are not equal. Owing to this design, an even planar light source is acquired.

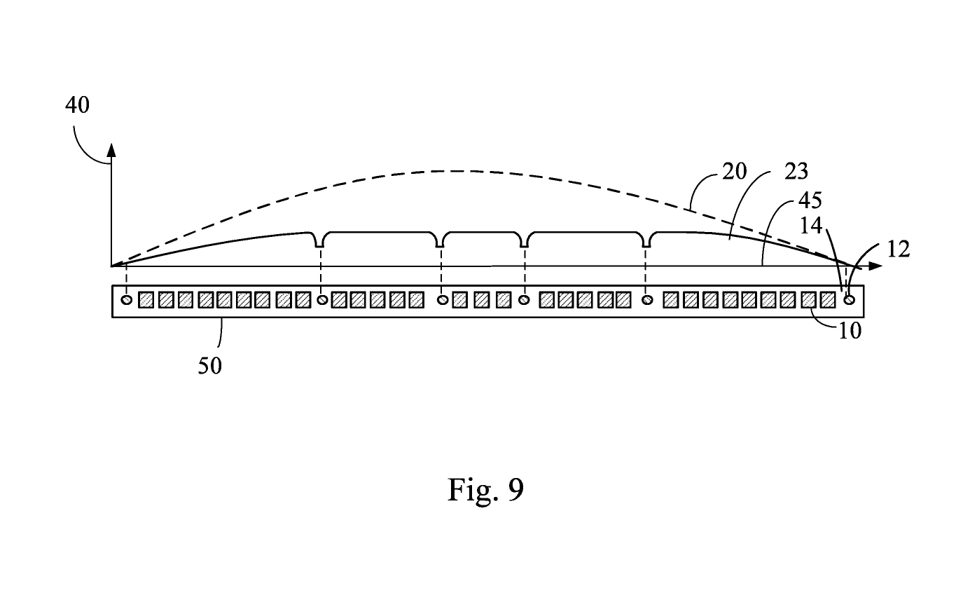

As described above, temperature is higher in the middle of the circuit board 14 while lower at the both sides of the circuit board 14 (temperature gradients are decreased) because of an accumulation of thermal energy of the plurality of LEDs 10 on the LED light bar 50. According to the present invention, the plurality of screws 12 are unequally arranged on the circuit board 14. For example, some of the screws 12 in the middle portion of the circuit board 14 are more densely arranged, but the other of the screws 12 are more sparsely arranged at the two ends of the circuit board 14. In this way, temperature can be evenly distributed over the LED light bar 50. In other words, the density distribution of the plurality of screws 12 is determined by the variation of the temperature gradients. For instance, as shown in FIG. 7, Pi and Pj both indicate the number of LEDs 10 between every two neighboring screws 12, and i and j indicate two neighboring screws 12 disposed arbitrarily on the LED light bar 50. The number Pj of LEDs 10 between every two neighboring screws 12 in the middle portion of the circuit board 14 (i.e., the plurality of screws 12 are more densely arranged) is less than the number Pi of LEDs 10 between every two neighboring screws 12 at both sides of the circuit board 14 (i.e., the plurality of screws 12 are more sparsely arranged). In this way, temperature becomes evenly distributed over the LED light bar 50. Referring to FIG. 9, FIG. 9 shows a structure diagram of an LED light bar 50 and a coordinate graph illustrating a temperature profile thereof according to a first embodiment of the present invention.

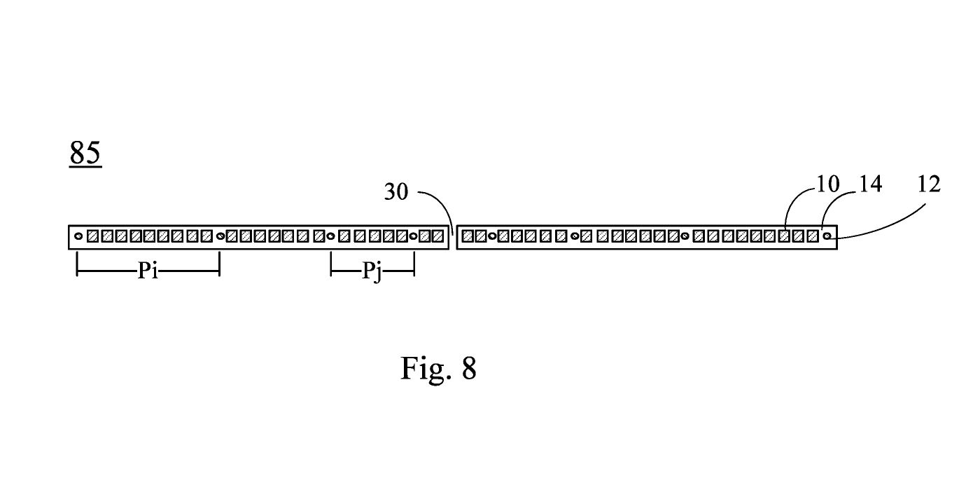

Referring to FIG. 8, FIG. 8 shows an LED light bar 85 according to a second embodiment of the present invention. Compared with the LED light bar 50 in FIG. 7, two adjacent circuit boards (e.g., a first circuit board 14 and a second circuit board 14) are arranged in a row and are disposed on a heat sink (not shown) on the LED light bar 85 in FIG. 8. There is an air gap 30 between the first and second circuit boards 14. The air gap 30 is used for hindering heat transmission between the first and second circuit boards 14. Thermal energy produced by the plurality of LEDs 10 is dissipated through the heat sink at the bottom of the first and second circuit boards 14. Thus, temperature which the air gap 30 corresponds to is lowered.

The plurality of LEDs 10 are arranged in a direction parallel to the surface of the first and second circuit boards 14. The plurality of screws 12 are inserted between the plurality of LEDs 10. The distance between any two adjacent screws 12 is gradually increased from the middle portion to the two ends of the heat sink. That is, the distance between the two adjacent screws 12 situated at the junction area of the first circuit board 14 and the second circuit board 14 is shorter than that between the other two adjacent screws 12 disposed on the first and second circuit boards 14.

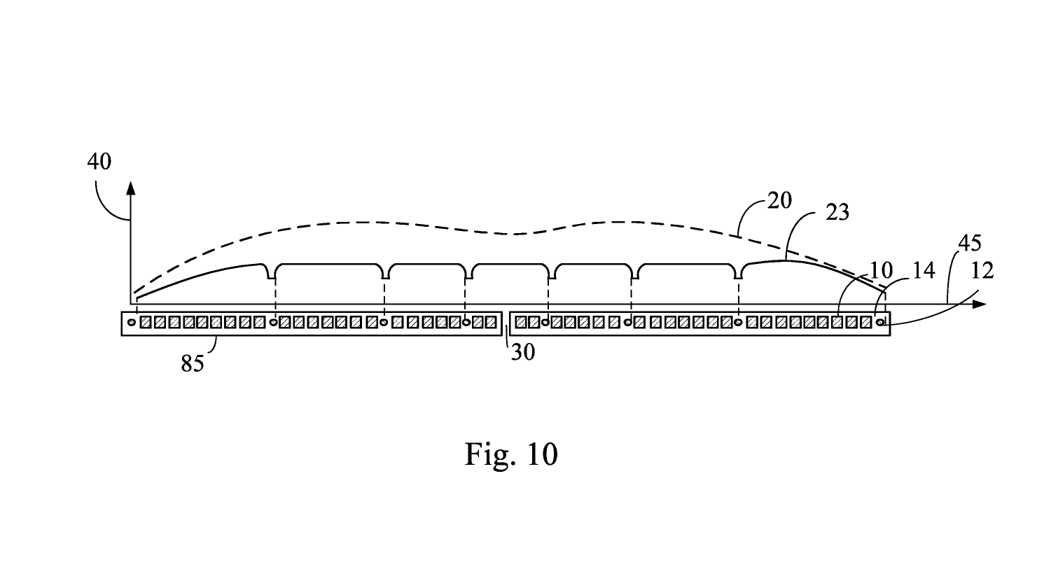

Referring to FIG. 10, FIG. 10 shows a structure diagram of the LED light bar 85 and a coordinate graph illustrating a temperature profile thereof according to a second embodiment of the present invention. The arrangement method and fabrication principle of the plurality of screws 12 according to the second embodiment is similar to that according to the first embodiment, so no further details are released hereafter.

As a result, temperature can be distributed more evenly over the LED light bar through the adjustment of density and spatial arrangements of the plurality of screws, thereby achieving an object of improving image quality of display devices.

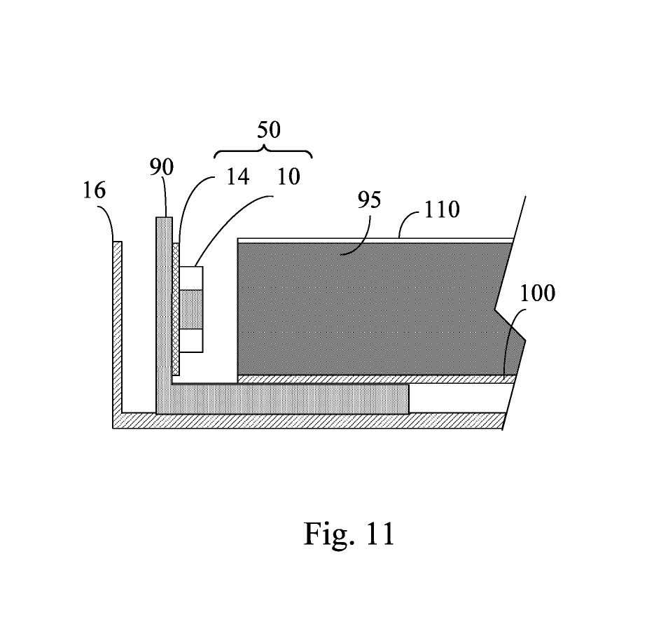

Referring to FIG. 11 showing a backlight module according to a third embodiment of the present invention, the backlight module is disposed on a heat sink 16 of a display device. The backlight module comprises an LED light bar 50, a reflector 100, an LGP 95, and at least one optical layer 110 such as a diffuser sheet. The LGP 95 is situated at the bottom of the at least one optical layer 110 and on top of the reflector 100. The structure of the LED light bar 50 is identical with that of the LED light bar used for the first or second embodiment. The LED light bar 50 comprises a plurality of LEDs 10, at least one circuit board 14 (including a plurality of circuit boards), a heat sink 16, and a plurality of screws 12 (not shown). The plurality of LEDs 10 are used for emitting light. The at least one circuit board 14 comprises a surface where the plurality of LEDs 10 are disposed and at least one trace for connecting the plurality of LEDs 10. The at least one circuit board 14 may be fixed on the heat sink 16 or on a vertical wall of a frame 90. The at least one circuit board 14 is fixed on the heat sink 16 with the plurality of screws 12. The plurality of screws 12 are arranged at an unequal distance. The plurality of LEDs 10 are arranged in a direction parallel to the surface of the at least one circuit board 14. The plurality of screws 12 are inserted between the plurality of LEDs 10. The distance between any two adjacent screws 12 is gradually increased from the middle portion to the two ends of the heat sink. The backlight module according to the third embodiment of the present invention is a side light type backlight module where the at least one circuit board 14 is fixed on the heat sink 16 or on the vertical wall of the frame 90. Accordingly, the LED light bar 50 is disposed at sides of the LGP 95. The plurality of LEDs 10 emit light at the sides of the LGP 95. The light is guided by the LGP 95 and reflected by the reflector 100. Then, the light becomes a highly bright and uniformly luminous planar light source serving as a light source for the entire display device.

To make temperature evenly distributed, the design and arrangement of the plurality of screws depends upon temperature distribution over the LED light bar according to the present invention, replacing the equally spaced arrangement of the plurality of screws in the conventional technology. In this way, temperature can be more evenly distributed over the LED light bar, thereby improving image quality of display devices.

What is claimed is:

1. A backlight module, disposed on a frame of a display device, and comprising a light guide plate (LGP) and at least one light emitting diode (LED) light bar, the LGP comprising an incident surface, the LED light bar being adjacent to the incident surface, characterized in that: the LED light bar comprises:
a plurality of LEDs, for emitting light;
a first circuit board, comprising a surface where the plurality of LEDs and at least one trace for driving the plurality of LEDs are disposed;
a heat sink, disposed at a back side of the at least one circuit board, and comprising two ends and a middle portion therebetween; and
a plurality of screws, for fixing the at least one circuit board on the heat sink, and arranged at an unequal distance.

2. The backlight module of claim 1, characterized in that: the plurality of LEDs are arranged in a direction parallel to the surface of the first circuit board, the plurality of screws are inserted between the plurality of LEDs, and the distance between any two adjacent screws is gradually increased from the middle portion to the two ends of the heat sink.

3. The backlight module of claim 1, characterized in that: the plurality of LEDs are arranged in a direction parallel to the surface of the first circuit board, the plurality of screws are inserted between the plurality of LEDs, wherein some of the screws are more densely arranged in the middle portion of the heat sink and the other of the screws at the two ends of the heat sink are more sparsely arranged.

4. The backlight module of claim 1, characterized in that: the backlight module further comprises a second circuit board arranged with the first circuit board adjacently, and the plurality of LEDs are disposed on the surface of the first and second circuit boards equally.

5. The backlight module of claim 4, characterized in that: the plurality of LEDs are arranged in a direction parallel to the surface of the first and second circuit boards, the plurality of screws are inserted between the plurality of LEDs, and the distance between any two adjacent screws is gradually increased from the middle portion to the two ends of the heat sink.

6. The backlight module of claim 4, characterized in that: the plurality of LEDs are arranged in a direction parallel to the surface of the first and second circuit boards, the plurality of screws are inserted between the plurality of LEDs, wherein the distance between the two adjacent screws situated at the junction area of the first circuit board and the second circuit board is shorter than that between the other two adjacent screws disposed on the first and second circuit boards.

7. A light emitting diode (LED) light bar, characterized in that: the LED light bar comprises:
a plurality of LEDs, for emitting light;
a first circuit board, comprising a surface where the plurality of LEDs and at least one trace for driving the plurality of LEDs are disposed;
a heat sink, disposed at a back side of the at least one circuit board, and comprising two ends and a middle portion therebetween; and
a plurality of screws, for fixing the at least one circuit board on the heat sink, and arranged at an unequal distance.

8. The backlight module of claim 7, characterized in that: the plurality of LEDs are arranged in a direction parallel to the surface of the first circuit board, the plurality of screws are inserted between the plurality of LEDs, and the distance between any two adjacent screws is gradually increased from the middle portion to the two ends of the heat sink.

9. The LED light bar of claim 7, characterized in that: the plurality of LEDs are arranged in a direction parallel to the surface of the first circuit board, the plurality of screws are inserted between the plurality of LEDs, wherein some of the screws are more densely arranged in the middle portion of the heat sink and the other of the screws at the two ends of the heat sink are more sparsely arranged.

10. The LED light bar of claim 7, characterized in that: the LED light bar further comprises a second circuit board arranged with the first circuit board adjacently, and the plurality of LEDs are disposed on the surface of the first and second circuit boards equally.

11. The LED light bar of claim 7, characterized in that: the plurality of LEDs are arranged in a direction parallel to the surface of the first and second circuit boards, the plurality of screws are inserted between the plurality of LEDs, and the distance between any two adjacent screws is gradually increased from the middle portion to the two ends of the heat sink.

12. The LED light bar of claim 7, characterized in that: the plurality of LEDs are arranged in a direction parallel to the surface of the first and second circuit boards, the plurality of screws are inserted between the plurality of LEDs, wherein the distance between the two adjacent screws situated at the junction area of the first circuit board and the second circuit board is shorter than that between the other two adjacent screws disposed on the first and second circuit boards.

13. An LED light bar, comprising:
a plurality of LEDs, for emitting light;
a plurality of circuit boards, every two of which arranged adjacently, each circuit board comprising a surface where the plurality of LEDs and at least one trace for driving the plurality of LEDs are disposed;
a heat sink, disposed at a back side of the plurality of circuit boards, and comprising a middle portion and two ends of the middle portion; and
a plurality of screws, used for fixing the plurality of circuit boards on the heat sink, characterized in that: the plurality of screws are arranged at an unequal distance.

14. The LED light bar of claim 13, characterized in that: the plurality of LEDs are arranged in alignment with the surfaces of the plurality of circuit boards, the plurality of screws are inserted between the plurality of LEDs, and the distance between any two adjacent screws is gradually increased from the middle portion to the two ends of the heat sink.

15. The LED light bar of claim 13, characterized in that: the plurality of LEDs are arranged in alignment with the surface of the plurality of circuit boards, the plurality of screws are inserted between the plurality of LEDs, wherein some of the screws are more densely arranged in the middle portion of the heat sink and the other of the screws at the two ends of the heat sink are more sparsely arranged.
